(19) United States
(12) Patent Application Publication
(10) Pub. No.: US 2025/0100072 A1
(43) Pub. Date: Mar. 27, 2025

(54) SYSTEM AND METHOD FOR THE FAULT MONITORING OF LASER WELDING PROCESSES

(71) Applicant: TRUMPF Laser GmbH, Schramberg (DE)

(72) Inventors: Andreas Jahn, Dornhan (DE); Julia Ziegler, Rottweil (DE); Patricia Maria Dold, Elzach/Oberprechtal (DE)

(21) Appl. No.: 18/976,409

(22) Filed: Dec. 11, 2024

Related U.S. Application Data
(63) Continuation of application No. PCT/EP2023/065162, filed on Jun. 7, 2023.

(30) Foreign Application Priority Data
Jun. 20, 2022 (DE) 10 2022 115 255.3

(51) Int. Cl. B23K 26/03; B23K 26/21; B23K 31/00; B23K 31/12

(52) U.S. Cl. CPC B23K 26/032; B23K 26/21; B23K 31/006; B23K 31/125

(57) ABSTRACT

A system for fault monitoring of laser welding processes on a component that is to be processed or has been processed by a laser processing apparatus includes an image recording device for creating two-dimensional image data of the component, and an evaluation unit configured to, based on the two-dimensional image data created by the image recording device, determine associated height values and create a height profile of the component by using a convolutional neural network.

### CROSS REFERENCE TO RELATED APPLICATIONS

This application is a continuation of International Application No. PCT/EP2023/065162 (WO 2023/247177 A1), filed on Jun. 7, 2023, and claims benefit to German Patent Application No. DE 10 2022 115 255.3, filed on Jun. 20, 2022. The aforementioned applications are hereby incorporated by reference herein.

### FIELD

Embodiments of the present invention relate to systems and methods for the fault monitoring of laser welding processes.

### BACKGROUND

In laser welding processes, monitoring the quality of a weld seam is essential for ensuring high-quality components. After production the weld seams are therefore subjected to a post-process inspection in which the quality of the weld seams is deduced by evaluation of image data of the weld seams. In addition, on the basis of the component configuration before the welding process it is possible to assess whether a stable process can be carried out. This configuration is also determined by the evaluation of image data. In both applications, the height information of the component offers an added value and can cover additional requirements in respect of the component configuration and quality assurance.

One example in which it is important to monitor weld seams is the production of electric motors and generators having a stator wound using hairpin technology, wherein adjacent hairpin ends are welded according to a circuit layout by means of a laser in order to establish the electrical contacting of the pins. Weld seams in which the hairpin ends were faultily welded to one another are reworked—if possi—le-in a second step, since otherwise the entire stator becomes unusable.

The weld seam quality is influenced by multiple parameters such as material quality, beam deviations and environmental factors. Fault cases are manifested for example by material being ejected to an excessively great extent, or by a deficient penetration depth of the laser beam into the material of the component. In the context of welding hairpins, the fault cases can be recognized inter alia on the basis of an excessively large or excessively small weld bead, spatter or by virtue of a mutual height offset of the pins before the welding process. Consequently, besides a two-dimensional recording of the surface of a component, the height profile of the component is also important for finding and characterizing faults.

The optical quality control of the weld seams generally takes place either by way of a 3D scan or by means of optical coherence tomography by way of a corresponding OCT (optical coherence tomography) scanner at the laser processing apparatus, or by means of greyscale photography by way of a camera that creates a two-dimensional greyscale image of the component. 3D scans produce a very accurate three-dimensional image of the component, but require long recording times and can therefore be integrated only with difficulty in an ongoing manufacturing process. In the case of two-dimensional greyscale images, by contrast, it is possible to analyse the height structure of a weld seam only very inaccurately and/or using multiple cameras.

DE 10 2018 129 425 A1 discloses converting image data and height data of a workpiece into information about the processing quality by means of a transfer function, wherein the transfer function is formed by a deep convolutional network which can be adapted to changed situations, for example other workpieces, by means of transfer learning. The image and height data are captured by an OCT scan, a stereo camera system and/or a triangulation system. This known system for fault monitoring is therefore relatively complex and requires a long evaluation time.

DE 10 2010 017 316 A1 describes a welding system equipped with multiple cameras which record the component from a plurality of different points and create a stereoscopic image of a weld bead. The height and the width of the weld bead can be calculated from this image.

### SUMMARY

Embodiments of the present invention provide a system for fault monitoring of laser welding processes on a component that is to be processed or has been processed by a laser processing apparatus. The system includes an image recording device for creating two-dimensional image data of the component, and an evaluation unit configured to, based on the two-dimensional image data created by the image recording device, determine associated height values and create a height profile of the component by using a convolutional neural network.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a-1g show various illustrations of a hairpin after a laser welding process according to some embodiments;

FIGS. 2a-2c show a greyscale image, a 3D scan and a 3D reconstruction using a system according to embodiments of the invention in respect of a first welded hairpin; and

FIGS. 3a-3c show a greyscale image, a 3D scan and a 3D reconstruction using a system according to embodiments of the invention in respect of a second welded hairpin.

### DETAILED DESCRIPTION

Embodiments of the present invention can enable reliable fault monitoring of laser welding processes which is able to be carried out rapidly.

Embodiments of the present invention provide a system for the fault monitoring of laser welding processes on a component which has been processed by a laser processing apparatus, comprising an image recording device for creating two-dimensional image data of the component that is to be processed or has been processed and an evaluation unit for the image data, which is characterized in that the evaluation unit is configured in such a way that, for the two-dimensional image data created by the image recording device, by means of a convolutional neural network, the evaluation unit calculates associated height values and creates a height profile of the component.

A height profile of the component can be generated from a single two-dimensional image recording with the aid of the convolutional neural network, which is preferably a deep convolutional neural network. The calculated height values approximate the actual height values of the component, wherein the deviation between calculated and actual height values can be kept very small by a well-trained neural network. The calculated three-dimensional image is a kind of height map of the component which can be used to ascertain not only the location of a fault in a weld seam but also the type of fault. The creation of the height map requires only little computation time and can therefore be integrated into the component manufacturing process. A time-consuming three-dimensional scan of the component is not necessary for this. Such scans are necessary only during the training phase of the network.

Preferably, the image recording device can create two-dimensional image data for pixels of a pixel matrix of the image of the component recorded by said image recording device, and the evaluation unit can calculate an associated height value for each of the pixels. The resulting height profile thus has a resolution identical to that of the two-dimensional image recording. Consequently, the processing of the two-dimensional image data by the neural network does not lead to losses in regard to the accuracy for ascertaining faults.

In this case, the evaluation unit can create a three-dimensional representation at least for a portion of the component surface that is relevant for ascertaining faults. This can have the effect that the number of pixels in the two-dimensional representation is higher than that in the three-dimensional representation of the component. The resolution in the two-dimensional representation and the resolution in the three-dimensional representation can nevertheless be identical.

For ascertaining the two-dimensional image data, the image recording device can comprise at least one camera aligned coaxially with a laser processing head of the laser processing apparatus. Said camera can preferably be a greyscale camera. It goes without saying, however, that colour recordings of the component are also possible. The use of multiple cameras that make recordings of the component from different positions can also be provided. The use of multiple cameras is advantageous in particular for training the convolutional neural network and can replace a scanner in this case.

However, the system can also comprise a 3D scanner, in particular an OCT scanner, which creates a height profile of the component and transfers it to the evaluation unit. The camera images and height profiles serve as training data for the neural network. The scans are needed only for training the network and are not constantly needed for fault monitoring. Its high accuracy can be used for very effective training of the neural network.

Furthermore, it is possible, in the event of a change in manufacturing circumstances, to create a scan of the component which the evaluation unit uses to once again train the convolutional neural network for calculating the associated height values for the two-dimensional image data of the component. This allows the neural network to be adapted to new situations by transfer learning. A new manufacturing circumstance may be for example a new position of the component or the changeover to a new type of component.

The height profile of the component generated by the evaluation unit can be compared with stored three-dimensional fault representations. This allows a direct categorization of a recognized fault and thus also a corresponding quality assessment of the component.

The convolutional neural network can preferably be a modified U-Net. These networks have proved worthwhile generally in image processing and in particular in semantic segmentation.

Embodiments of the present invention additionally provide a laser processing apparatus comprising a laser processing head for producing weld seams on a component, and a system for the fault monitoring of laser welding processes on the component.

Embodiments of the invention also relate to a method for the fault monitoring of laser welding processes on a component which has been processed by a laser processing apparatus, comprising the following steps:
capturing two-dimensional image data of the component surface which is to be processed or has been processed,
calculating associated height values for the two-dimensional image data by means of a convolutional neural network, creating a height profile of the component,
wherein the neural network was trained beforehand with image data and associated height profiles, for the calculation of the height values.

The neural network can be retrained at any time if a further refinement of the results is desired. An adaptation of the convolutional neural network to changed manufacturing circumstances such as other components, component positions or changed manufacturing parameters is also possible by way of transfer learning of the network.

An application of the system and its results are described in greater detail below.

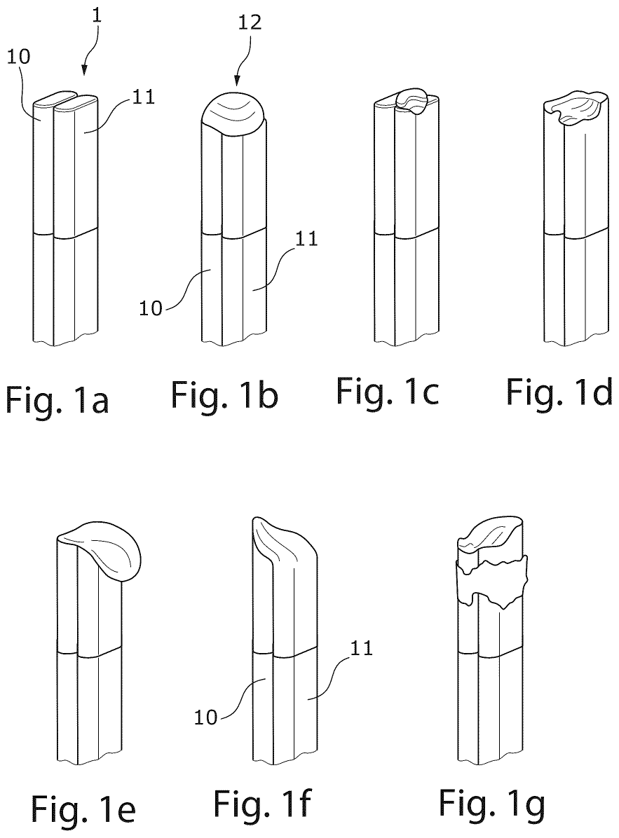

The hairpin 1 shown in FIG. 1a comprises two copper bar ends that have to be welded to one another in order to produce an electrical contact. The hairpin 1 is part of a winding (not illustrated here) of a stator of an electric motor. Hairpins are regularly laser-welded and checking the quality of the weld seams is important here since all the hairpins of a stator have to be welded to one another in such a way that the electrical contacts are reliably produced.

FIG. 1b illustrates a good weld of the copper bars 10, 11 of the hairpin 1. The weld seam 12 has a smooth, slightly curved surface.

By contrast, FIGS. 1c to 1g show various possible faults during the welding of the hairpin 1. In FIG. 1c, the hairpin 1 was not at the focus of the laser during welding. FIG. 1d shows a weld seam which was produced using too little power of the laser, whereas in FIG. 1e the hairpin 1 was welded using too much power. In FIG. 1f, the copper bars 10, 11 have a mutual offset, and in FIG. 1g, the insulation has not been stripped from the copper bars 10, 11.

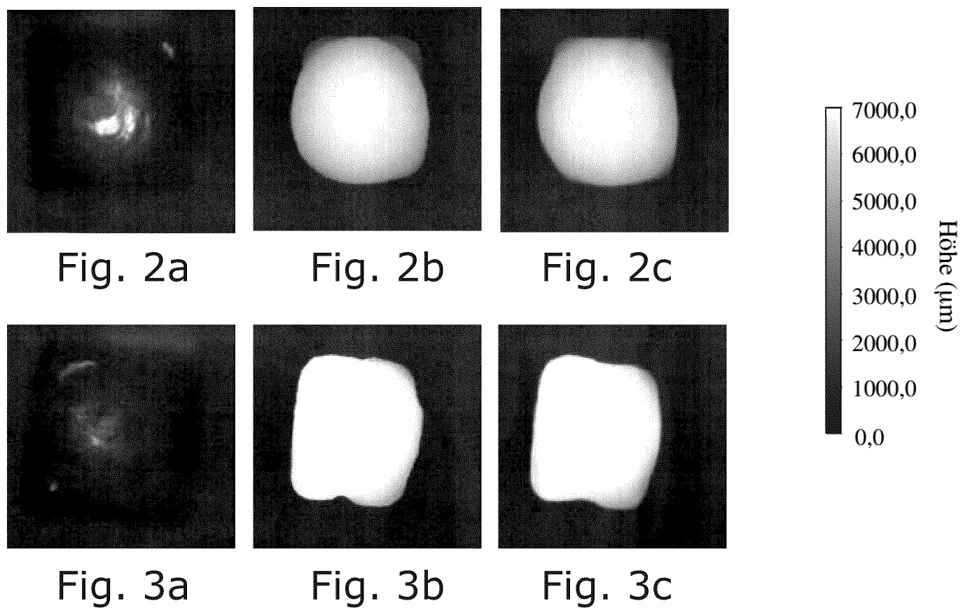

FIGS. 2 and 3 elucidate how a weld seam 12 of a hairpin 1 can be three-dimensionally represented and assessed using a system and method according to embodiments of the invention.

FIG. 2a shows a two-dimensional greyscale image of a good weld seam 12 of a hairpin 1 (see FIG. 1b). FIG. 2c shows the three-dimensional representation of the weld seam 12 reconstructed from the greyscale image from FIG. 2a with the aid of a convolutional neural network. Convolutional Neural Network is also used as a term in German. For this purpose, the convolutional neural network calculates approximate values for the actual height values of the component for each pixel of the greyscale image from FIG. 2a. The lighter the colour in the representation in FIG. 2c, the greater the height value, as made clear by the scale next to FIG. 2. For comparison, FIG. 2b illustrates a three-dimensional OCT scan of the same hairpin. The computational reconstruction in FIG. 2c deviates only insignificantly from the OCT scan and makes it clear that the system and method according to embodiments of the invention make it possible to evaluate the quality of a weld seam 12 just as reliably as a very much more time-consuming OCT scan.

FIG. 3a shows a greyscale image of a faulty weld seam. The three-dimensional representation reconstructed therefrom in FIG. 3c makes it clear, by virtue of the lighter colour in comparison with FIG. 2c, that the weld seam is too high. From this and owing to the still clearly recognizable contours of the two copper bars 10, 11 of the hairpin 1, it can be deduced that the hairpin in FIG. 3 was welded with an excessively low laser power, in a similar manner to the hairpin shown in FIG. 1c. Here, too, FIG. 3b shows for comparison a three-dimensional OCT scan of the same hairpin, which again proves that the height values in FIG. 3c were calculated very accurately by the convolutional neural network.

The convolutional neural network for calculating the three-dimensional reconstructions of the hairpins shown in FIGS. 2c and 3c was trained with three-dimensional OCT scans of hairpins. The network is part of an evaluation unit (not shown), in which comparative image representations of faultily welded hairpins may also be stored. In this way, the evaluation unit can also directly carry out an assessment and categorization of the weld seams on the basis of the three-dimensional reconstructions of the hairpins in FIGS. 2c and 3c.

It goes without saying that the system and method according to embodiments of the invention can also be applied to weld seams of components other than hairpins. In addition, the convolutional neural network can be modified such that other instances of laser processing of a component such as laser cuts, for example, can be assessed by way of the three-dimensional reconstruction of the component from greyscale recordings.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A system for fault monitoring of laser welding processes on a component that is to be processed or has been processed by a laser processing apparatus, the system comprising:
an image recording device for creating two-dimensional image data of the component; and
an evaluation unit configured to, based on the two-dimensional image data created by the image recording device, determine associated height values and create a height profile of the component by using a convolutional neural network.

2. The system according to claim 1, wherein the image recording device creates the two-dimensional image data for pixels of a pixel matrix of an image of the component recorded by the image recording device, and the evaluation unit determines a respective associated height value for each of the pixels.

3. The system according to claim 1, wherein the image recording device comprises at least one camera aligned coaxially with a laser processing head of the laser processing apparatus.

4. The system according to claim 3, wherein the at least one camera is a greyscale camera.

5. The system according to claim 1, further comprising a scanner configured to create a scan of the component and transfer the scan to the evaluation unit, wherein the evaluation unit is configured to use the scan to train the convolutional neural network for determining the associated height values for the two-dimensional image data.

6. The system according to claim 5, wherein in an event of a change in manufacturing circumstances, the system creates a new scan of the component using the scanner, wherein the evaluation unit uses the new scan to train the convolutional neural network again for determining the associated height values for the two-dimensional image data of the component.

7. The system according to claim 1, wherein the evaluation unit is configured to create a three-dimensional representation for at least a portion of a surface of the component.

8. The system according to claim 7, wherein the evaluation unit is configured to compare the generated three-dimensional representation of the surface of the component with three-dimensional fault representations stored in the evaluation unit.

9. The system according to claim 1, wherein the convolutional neural network is a modified U-Net.

10. A laser processing apparatus comprising a laser processing head for producing weld seams on a component, wherein the laser processing apparatus comprises a system according to claim 1.

11. A method for fault monitoring of laser welding processes on a component that is to be processed or has been processed by a laser processing apparatus, the method comprising:
capturing two-dimensional image data of a surface of the component,
determining associated height values for the surface of the component based on the two-dimensional image data by using a convolutional neural network, and
creating a height profile of the component based on the associated height values,
wherein the convolutional neural network is trained beforehand with previous image data and associated previous height profiles of the component.
